(19) United States
(12) Patent Application Publication
(10) Pub. No.: US 2022/0378264 A1
(43) Pub. Date: Dec. 1, 2022

(54) Industrial Robotic Vacuum System

(71) Applicants: Joshua G. Bardell, Spokane, WA (US); Samuel C. Bardell, Pasco, WA (US)

(72) Inventors: Joshua G. Bardell, Spokane, WA (US); Samuel C. Bardell, Pasco, WA (US)

(21) Appl. No.: 17/824,880

(22) Filed: May 25, 2022

Related U.S. Application Data
(60) Provisional application No. 63/193,592, filed on May 26, 2021.

(51) Int. Cl. A47L 9/28; A47L 9/04; A47L 9/24; A46B 13/02; A46B 13/00; A46B 15/00

(52) U.S. Cl. CPC A47L 9/2847; A47L 9/2852; A47L 9/0472; A47L 9/2805; A47L 9/248; A47L 9/0411; A47L 9/0477; A46B 13/02; A46B 13/008; A46B 13/001; A46B 15/0006; A47L 2201/04; A47L 2201/06; A46B 2200/3073

(57) ABSTRACT

An industrial robotic vacuum system for cleaning agricultural facility ventilation ductwork. The industrial robotic vacuum system generally includes a robotic vacuum head.

### CROSS REFERENCE TO RELATED APPLICATIONS

I hereby claim benefit under Title 35, United States Code, Section 119(e) of U.S. provisional patent application Ser. No. 63/193,592 filed 26 May 2021. The 63/193,592 application is currently pending. The 63/193,592 application is hereby incorporated by reference into this application.

### STATEMENT REGARDING FEDERALLY SPONSORED RESEARCH OR DEVELOPMENT

Not applicable to this application.

### BACKGROUND OF THE INVENTION

### Field of the Invention

The present invention relates generally to an industrial vacuum and more specifically it relates to an industrial robotic vacuum for cleaning agricultural facility ventilation ductwork.

### Description of the Related Art

Any discussion of the related art throughout the specification should in no way be considered as an admission that such related art is widely known or forms part of common general knowledge in the field.

Agricultural facilities are commonly constructed with storage for various agricultural products that may have a large amount of dirt, soil, and other debris clinging thereto. Root vegetables such as potatoes, onions, carrots, yams, and the like are among the dirtiest of these. When they are placed in storage, the dirt, soil, and other debris will fall off of the agricultural product into ventilation air ducts beneath, which are used to pump cooling air, which may be moist for some product and dry for others (humidity levels may range from 0-100% depending on the produce), up through the stored product. These ducts then need to be cleaned out to ensure proper air flow and to maintain cleanliness generally. In most cases these ducts are cleaned out using a long hose attached to a vacuum and a person is required to manipulate the hose into the ducts, which can be 30 inches to 55 inches wide and 100 feet long, or even longer.

This cleaning method is problematic for several reasons. One, it is highly labor intensive. Two, the person(s) manipulating the hose and long sections thereof may not be able to see all the dirt and debris and in many cases has to crawl along the length of the duct personally to oversee the task. Three, the dirt, soil, and debris is often piled into large dense piles (between 6 inches and 22 inches high) that make conventional vacuum heads ill-suited to removing them. Four, the shape of the ductwork itself can often make conventional vacuum heads ill-suited to maneuvering in them (small opening, wider channel down/up-stream, ledges to fall over, etc.). Five, use of a single hose requires multiple traverses of the entire length of the ducts to clean out all the debris, and still requires a back flush of water which is not only incredibly time consuming taking as much as 3 to 4 weeks to clean all the ducts in any given facility, but the flushing water overwhelms sumps and is highly prone to clogging the sump pumps.

Because of the inherent problems with the related art, there is a need for a new and improved industrial robotic vacuum system for cleaning agricultural facility ventilation ductwork.

### BRIEF SUMMARY OF THE INVENTION

The present invention generally comprises a system for cleaning agricultural facility ventilation ductwork. The invention generally relates to an industrial robotic vacuum system, which includes a robotic vacuum head adapted to clean dense piles of dirt, soil, and debris from agricultural storage facility ventilation ductwork.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an industrial robotic vacuum system that will overcome the shortcomings of the prior art systems.

A second object is to provide an industrial robotic vacuum system adapted to clean within narrowing and widening agricultural facility ventilation ductwork.

A third object is to provide an industrial robotic vacuum system capable of removing dense piles of agricultural dirt, soil, and debris from agricultural facility ventilation ductwork.

A fourth object is to provide an industrial robotic vacuum system that has brushes attached to arms that move inward and outward to adjust to variations in ductwork width.

A fifth object is to provide an industrial robotic vacuum system equipped with dirt deflectors capable of directing dense piles of agricultural dirt, soil, and debris toward the vacuum head.

A sixth object is to provide an industrial robotic vacuum system that may be monitored and/or maneuvered by a remote user via a human machine interface (HMI).

A seventh object is to provide an industrial robotic vacuum system which includes cameras and ultrasonic monitors as part of a monitoring system that facilitates robotic operation.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of an industrial robotic vacuum according to the present invention.

FIG. 2 is a top view of an industrial robotic vacuum according to the present invention, having a top cover thereof removed.

FIG. 3 is a rear perspective view of an industrial robotic vacuum according to the present invention.

FIG. 4a is a top view of an industrial robotic vacuum according to the present invention including reference sectioning line.

FIG. 4 is a sectioned perspective view of an industrial robotic vacuum according to the present invention, sectioned along the sectioning line shown in FIG. 4A.

FIG. 5 is a block diagram of a system in which an industrial robotic vacuum may operate according to the present invention.

### DETAILED DESCRIPTION OF THE INVENTION

### A. Overview.

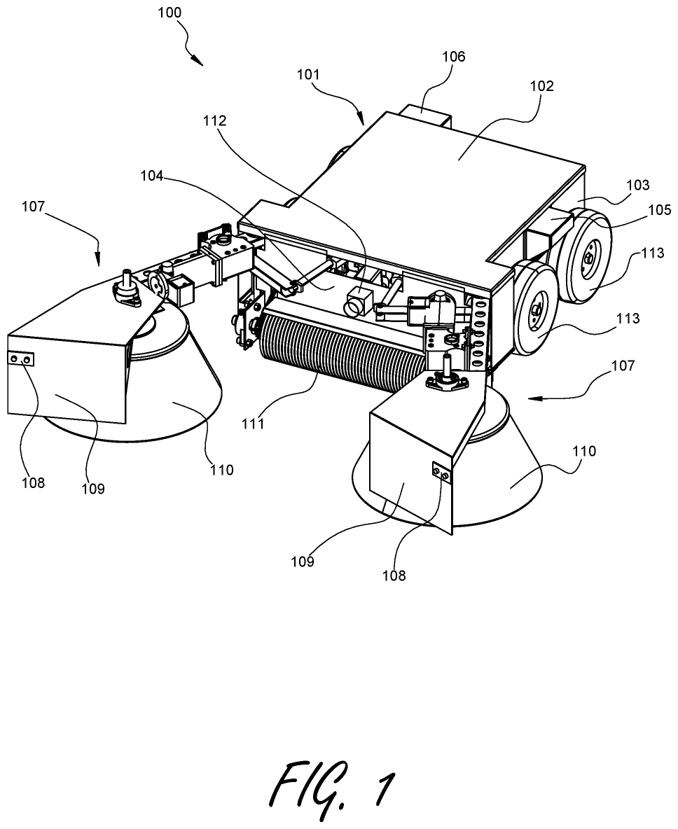

Turning now descriptively to the drawings, in which similar reference characters denote similar elements throughout the several views, FIGS. 1 through 4 and 4a illustrate an industrial robotic vacuum system 100, which comprises a robotic vacuum head.

### B. Housing Assembly.

The industrial robotic vacuum system 100 may be comprised of a housing assembly 101. The housing assembly 101 is a generally enclosed rigid structure consisting of a housing top cover 102 forming a first side, two opposing housing side plates 103 forming second and third sides, a housing front plate 104 forming a fourth side, a base mounting plate 212 forming a fifth side, and a housing rear plate 303, which may form a sixth side thereof. The various parts of housing assembly 101 may be made of welded or fastened steel sheet (using rivets, screws, or other similar fastening means) or other similar material with sufficient strength and weight to enable it to perform the task of pushing and sweeping dense debris piles and for mounting various apparatuses thereto including vacuum hoses, cabling, and internally mounted components such as motors, drive components, and electrical wiring and circuitry. Housing assembly 101 is the hub to which several subsystems are attached and may be further comprised of wheels 113, which enable the unit to be mobile, one or more articulating brush arm assemblies 107, which articulate to maneuver through and sweep debris from wider and narrower sections of ventilation duct and have arm brush heads 110, which are used to sweep up dirt and debris, and a front roller sweeper 111, which is used to direct dirt and debris directly into a vacuum duct 400.

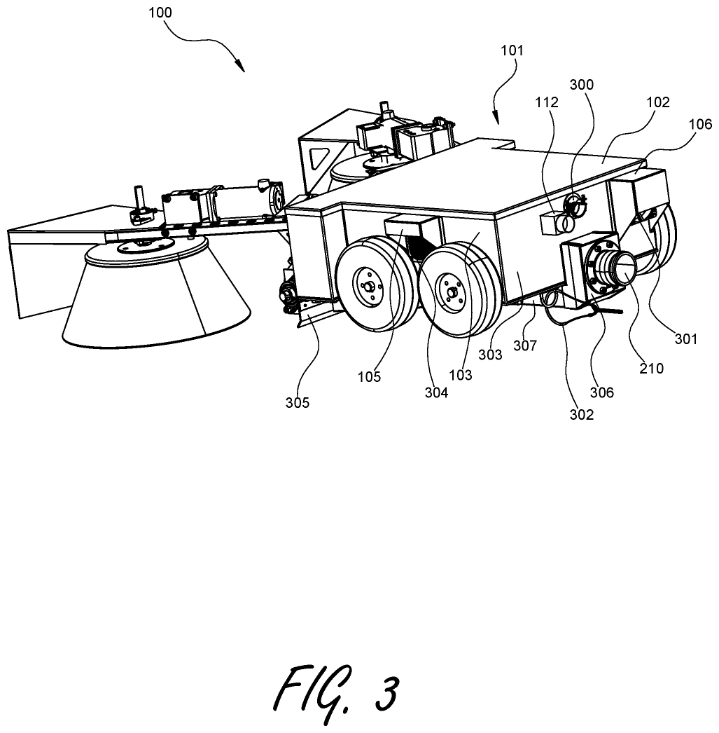

As noted, housing assembly 101 is generally enclosed meaning that the various sides thereof may have openings in them or be constructed to form openings in housing assembly 101 such as for ventilation of enclosed control and power circuitry and to facilitate movement of the internally mounted articulating arms 202 of brush arm assemblies 107 and their actuating components and linkages such as arm linear actuators 203. Various shrouds may be attached to housing assembly 101, such as fan outlet shroud 105 and fan inlet shroud 106 to prevent excessive dirt and debris from entering the generally enclosed structure of housing assembly 101. Finally, housing assembly 101 may have certain sensors and other peripheral equipment mounted thereon. For example, one or more cameras 112, which may be used by an operator to determine whether there is remaining debris within a duct that is being cleaned by the industrial robotic vacuum system 100, and one or more ultrasonic sensors 108, which may be used for determining a position of the industrial robotic vacuum system 100 relative to the various ducting walls, openings, or ledges therein. It should be noted that while camera 112 is shown mounted to a housing front plate 104, two or more cameras 112 may be included and mounted at various locations on the housing or other attached apparatuses so as to best convey visual information back to an operator or duct inspector. For example, FIG. 3 depicts a second camera 112 mounted to housing rear plate 303. Likewise, ultrasonic sensors 108 are depicted in FIG. 1 as being mounted to brush arm assemblies 106, however these or additional sensors may be mounted and located at various points on housing assembly 101, or wherever they may be best suited to gather positional data for controlling the robotic vacuum system 100. Likewise, housing assembly 101 may have a recovery strap 302 attached at a rear side thereof such as housing rear plate 303 or at a rear end of base mounting plate 212. Recovery strap 302 is useful for retrieving the industrial robotic vacuum system 100 in the event of power loss, lack of wheel contact with the duct, or other problem. Recovery strap 302 may serve as an attachment point for connecting a winch or strap by which the industrial robotic vacuum system 100 may be pulled backward thru the ductwork by an operator thereof, or by other automatic, or mechanical means.

Housing assembly 101 may be constructed so as to enclose and have mounted thereto, many operational components. For example, one or more wheel drive assemblies 205, which are used to drive wheels 113, may be mounted to base mounting plate 212 of housing assembly 101. Wheel drive assemblies 205 may include an electric motor, bearings, sprockets, gears, and axel couplings such as chain coupling 214 to drive wheels 113, which propel the industrial robotic vacuum system forward, backward, and left or right and ultimately to move it along the length of ductwork to facilitate cleaning thereof. In a preferred embodiment, one or more wheel drive assemblies are coupled together on each side via chain and sprocket linkage, to enable turning in a skid steer mode of operation. Other coupling mechanisms such as belt and pulley, as well as other steer modes of operation are contemplated and within the scope of the invention.

Housing assembly 101 may additionally have one or more front roller sweeper drive motor assemblies 213 mounted therein. Front roller sweeper drive motor assembly 213 may be comprised of an electric motor, bearings, sprockets, and gears, which when coupled to front roller sweeper 111 facilitate rotational motion thereof.

### C. Vacuum Duct Assembly.

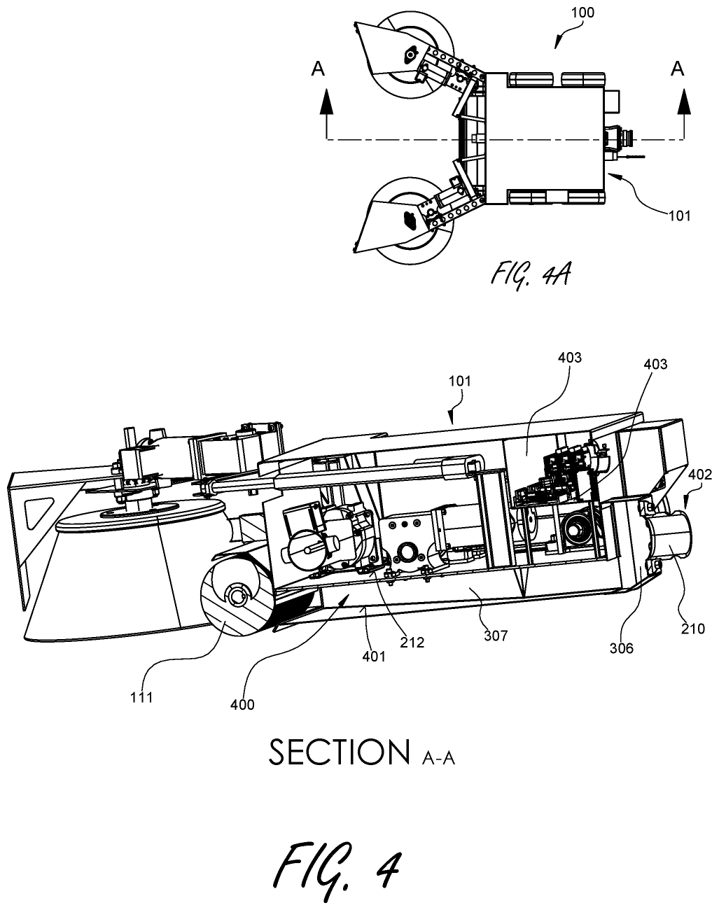

Housing assembly 101 may additionally have one or more vacuum duct assemblies 400 mounted thereto. For example, FIG. 4 shows a cross-sectional view of one such assembly attached to a bottom side of housing assembly 101 with base mounting plate 212 forming an upper side of the vacuum duct assembly 400. Thus, in a preferred embodiment, vacuum duct assembly may be generally comprised of two or more vacuum duct side plates 307, a vacuum duct bottom plate 401, and a vacuum duct end plate assembly 402 comprised of a vacuum duct end plate 306 and a vacuum hose coupler 210. In a preferred embodiment, vacuum duct assembly has roller sweeper 111 mounted to housing assembly 101 at the entrance end of vacuum duct assembly 400, such that roller sweeper 111 directs dirt and debris into vacuum duct assembly 400. Additionally, vacuum duct assembly 400 may include a duct scrape 305 to form a seal with an agricultural facility duct wall and assist with directing dirt and debris up into the duct assembly 400 of industrial robotic vacuum system 100. Vacuum duct assembly 400 and the various side plates, bottom plate, and end plate thereof may be constructed of steel sheet(s) that are welded or fastened together so as to form an aerodynamic pathway for air and entrained dirt, dust, and debris to flow back to an attached debris collection system 506. In a preferred embodiment duct scrape 305 may be constructed of metal similar to that of housing assembly 101 in order to thoroughly scrape up dirt and debris from the bottom of an air duct, however other materials such as a stiff rubber or other flexible composite material that is stiff enough to scrape dirt and debris from the agricultural ductwork without marring or gouging it is also contemplated. Duct scrape 305 may be attached to, for example, vacuum duct bottom plate at a front end thereof with a removable fastening means, such as screws or bolts or other similar means of attachment so that it can be replaced when sufficiently worn or functionally degraded.

### D. Brush Arm Assembly.

The industrial robotic vacuum assembly 100 may include one or more brush arm assemblies 107, for directing dirt and debris within agricultural storage facility ducts toward front roller sweeper 111. To facilitate this general mode of operation, brush arm assembly 107 may be comprised of an articulating arm 202, which serves as the primary rigid structure of brush arm assembly 107. Articulating arm 202 may be constructed of steel or other similar material that will have enough strength and rigidity to support the weight of attachments such as one or more arm brush motors 201, one or more rotating arm brush heads 110, and/or one or more debris deflectors 109, and the like as well as to bear the brunt forces of pushing, sweeping and moving dense dirt and debris. In a preferred embodiment, articulating arm 202 is articulated side to side by having one end attached to a pivot member affixed to housing assembly 101 and an arm linear actuator 203 attached to a lever member attached to articulating arm 202 at a fixed distance away from the pivot end of articulating arm 202 such that when the arm linear actuator 203 is extended brush arm assembly 107 articulates out to a wider position, and when arm linear actuator 203 is retracted brush arm assembly 107 articulates back to a narrower position relative to a centerline of the housing assembly 101 and ultimately closer to or away from a wall of an agricultural storage facility duct (respectively), in which the industrial robotic vacuum system 100 may be operating.

In a preferred embodiment, each brush arm assembly 107 is configured with a debris deflector 109 at a front end thereof. Debris deflectors 109 are designed to deflect the dense piles of debris which the robotic vacuum system may encounter within an agricultural facility duct. These dense piles are often in a wide range of sizes from 1 inch to 22 inches in height and debris deflectors 109 are therefore useful to help arm brush heads 110 break through these individual piles that, as noted, may vary in size. Debris deflectors 109 are therefore designed to push the piles of dirt over and leave a 2 to 3 inch pile of debris for the brushes to work though instead of the larger, less uniform piles as the robotic vacuum system moves forward or as the brush arm assembly 107 is articulated from side to side (these forward and side to side actions may occur in conjunction). This also allows for a steady rate of cleaning.

### E. Control/Power System.

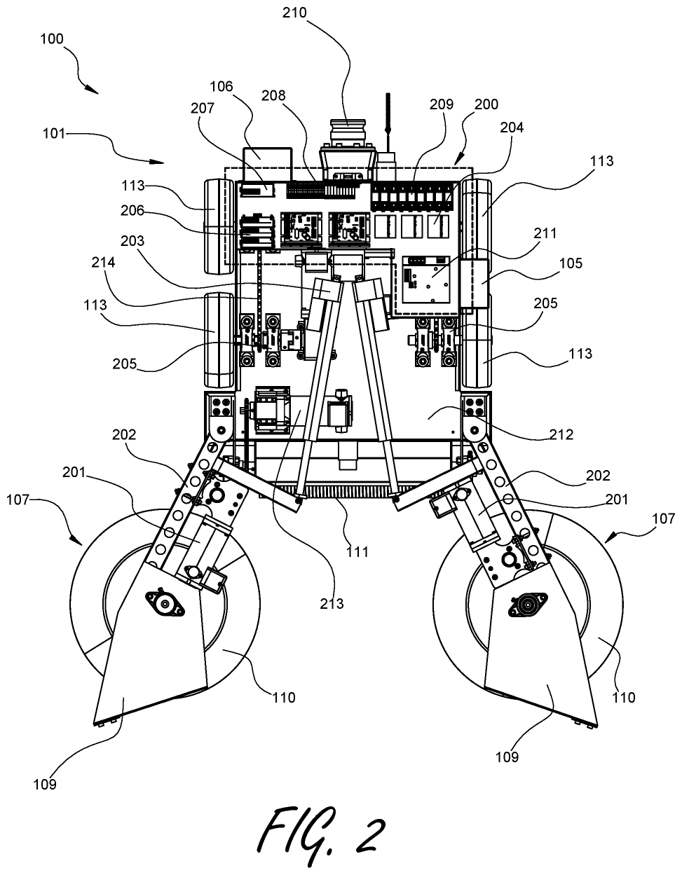

Housing assembly 101 may be configured to include a generally enclosed partition thereof, in which a control/power system 200 may be housed. FIG. 2 includes a dashed boundary, which generally represents this partition. The partition is useful for segregating components of control/power system 200 which may be sensitive to dust or other airborne particulates and require active/convective cooling such as air cooling and may be achieved by welding or attaching one or more internal dividing walls 403 of similar construction to that of the exterior. Accordingly, housing assembly 101 may be configured to have an air inlet at which one or more fans 301 may be mounted and an air outlet where one or more cooling air filters 304 may be mounted, and a sealed cable strain relief 300 where power and communication cabling enters the system. It should be noted that cooling air filters 304 may be mounted at both the inlet and outlet to ensure blowing dust and/or other airborne particulate matter does not enter the partition in which control/power system 200 resides.

Control/power system 200 may be generally comprised of all the electronic components necessary to operate the various motors, actuators, cameras, and gather data from ultrasonic sensors of the industrial robotic vacuum system. These components include but are not limited to, brush motor controllers 204, a PLC control bank 206, a 24V DC power supply 207, a fuse panel 208, a relay bank 209, and an AC to DC power converter 211. These components are well known to one of ordinary skill in the art and may be selected from any of the well-known types which are commercially available. Other components, which may be beneficial to operating the various components of the industrial robotic vacuum system 100, are contemplated. For example, an on-board computer system comprised of a motherboard, CPU, RAM, ROM, Modem, and hard drive may be utilized for control and operation of firmware or software associated with operational control. The industrial robotic vacuum system 100 may be configured for wired or wireless communication including but not limited to bluetooth, wifi, HDMI, optical, ethernet, USB, RS232, RS434, and etc.

### F. Operation of Preferred Embodiment.

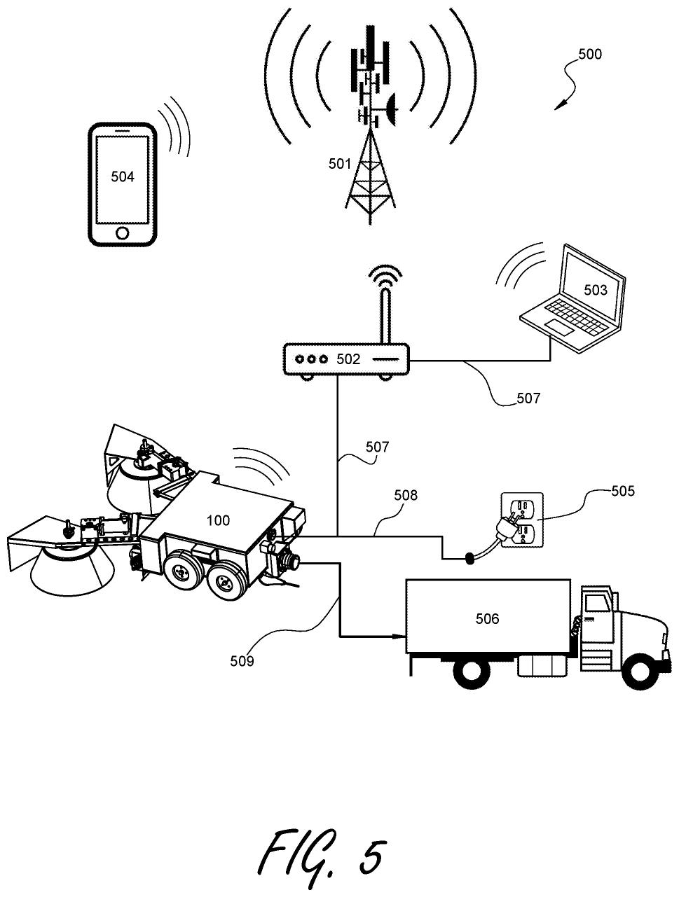

In use, the industrial robotic vacuum system 100 may operate in a system of operation 500 as depicted in FIG. 5. The industrial robotic vacuum system 100 derives its power for operation of the various motors, actuators, sensor, and control/power system components from a power source 505 via power connection 508. Power source 505 according to a preferred embodiment, may be a 120V AC industrial power source as is common in agricultural storage facilities. Alternatively, power source 505 may be a common 208V AC or 480V 3 phase power source, or the industrial robotic vacuum system 100 may be configured with internal batteries (such as lithium ion or other common rechargeable battery type) that supply power motor and actuator power, etc. during operation, and recharge using AC power source 505 when the unit is not operating. Power connection 508 may be a multi-pronged power cord of sufficient wire gauge and length to permit the industrial robotic vacuum system 100 to remain connected to power when the industrial robotic vacuum system 100 has traversed the entire length of the agricultural facility ductwork.

As the industrial robotic vacuum system 100 moves along the ductwork within an agricultural storage facility, the dirt and debris it collects via the rotating arm brush heads 110, and front roller sweeper 110, is sucked through vacuum duct assembly 400, into vacuum hose 509, and into a debris collection system 506. The arm brush motor 201 on a left side of the industrial robotic vacuum system 100 may be configured to rotate its corresponding rotating arm brush head 110 clockwise, while arm brush motor 201 on a right side of the industrial robotic vacuum system 100 may be configured to rotate its corresponding rotating arm brush head 110 counterclockwise, to direct dirt, soil and other agricultural debris toward front roller sweeper 111. In a preferred embodiment the speeds of the various arm brush heads 110 will be between 85-120 rpm. Debris collection system 506 may be a truck mounted or otherwise mobile unit that can be moved to, from, or within the agricultural storage facility and provide the requisite suctioning forces and collection bin to entrain and to collect dust, dirt, soil, and other debris swept up by the industrial robotic vacuum system 100. In a preferred embodiment vacuum hose 509 (and corresponding vacuum hose coupler 210) may be a 2 inch or 3 inch commercial vacuum hose as one of ordinary skill in the art would be familiar, though 4 inch to 6 inch vacuum hose sizes are contemplated as being appropriate.

The industrial robotic vacuum system 100 is programmed and intended to operate autonomously and use the onboard sensors (such as ultrasonic sensors 108) and cameras 112 to provide feedback for how to maneuver within a network of agricultural facility ductwork, for example, where the walls, ledges, and debris are, and whether the dirt, soil, and other debris have been thoroughly removed by the system and how fast or slow to operate the motors controlling the spin rate and direction of the wheels 113, arm brush heads 110, and/or front roller sweeper 111 and whether to extend or retract the brush arm assemblies 107 or whether to speed up or slow down the various motors controlling the various brushes. Programming of the industrial robotic vacuum may be accomplished via the wired communication connection 507, using any of the well-known communication protocols (Transmission Control Protocol (TCP), Internet Protocol (IP), User Datagram Protocol (UDP), Post office Protocol (POP), Simple mail transport Protocol (SMTP), File Transfer Protocol (FTP), Hyper Text Transfer Protocol (HTTP), Hyper Text Transfer Protocol Secure (HTTPS), and the like), or similarly via wireless communication via modem 502, for example. In a preferred embodiment, wired communication connection 507 is comprised of ethernet cable, however other cable types such as HDMI, USB, or coaxial cable may be used.

While the industrial robotic vacuum system 100 is an autonomous system, periodically, monitoring and/or remote control may be desired. This may be accomplished via either the wired communication connection 507 or wirelessly using any of the aforementioned communication protocols. A system user may interface with the industrial robotic vacuum system 100 using a mobile device 504 that is in direct, wired, or wireless communication with the industrial robotic vacuum system 100, or indirect communication via cell tower 501, or via modem 502, on in any combination thereof using application software running thereon. Mobile device 504 may be comprised of a cellular phone, tablet computer, or similar device. Network computer 503 may serve the same function as mobile device 504 and be connected similarly. Network computer 503 may be comprised of a notebook computer, desktop computer, or workstation as is commonly known in the art.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An industrial robotic vacuum system for cleaning agricultural ductwork comprising:
a housing assembly;
a vacuum duct assembly mounted to the housing assembly;
a drive mechanism mounted to the housing assembly to enable forward, backward, left, and right movement of the robotic vacuum within an agricultural duct network;
one or more articulating brush arm assemblies mounted to the housing assembly having one or more sensors mounted thereon, wherein the one or more articulating brush arm assemblies are configured to articulate from a first position near a centerline of the housing assembly to a second position away from the centerline of the housing; and
a control system mounted to the housing assembly for controlling the drive mechanism and to control the position of the one or more articulating brush arm assemblies in response to positional data collected from the one or more sensors indicating the robotic vacuum system has moved to a position within the agricultural duct network where the duct has widened.

2. The system of claim 1 wherein the sensors are ultrasonic sensors.

3. The system of claim 2, wherein the control system is additionally configured to move the one or more articulating brush arm assemblies closer to the centerline of the housing in response to collected data indicating the robotic vacuum has moved to a position within the agricultural duct network where the duct has narrowed.

4. The system of claim 1 wherein the one or more articulating brush arm assemblies further comprises a debris deflector configured to deflect debris toward a centerline of the housing and ultimately toward the vacuum duct assembly.

5. The system of claim 1 wherein the one or more articulating brush arm assemblies further comprises:
an arm;
a brush head assembly mounted to the arm for sweeping agricultural debris; and
a linear actuator coupled to the arm and controlled by the control system.

6. The system of claim 5 wherein the brush head assembly is configured to rotate clockwise if the brush arm assembly is mounted on a left side of the housing and counter clockwise if the brush arm assembly is mounted on a right side of the housing.

7. The system of claim 1 wherein the housing additionally has a recovery strap mounted to a rear side for retrieval of the system in the event of a mechanical or electrical failure.

8. The system of claim 1 wherein the vacuum duct assembly includes a duct scrape to form a seal with an agricultural duct to assist with directing agricultural debris into the vacuum duct assembly.

9. A method of operating an industrial robotic vacuum system for cleaning agricultural ductwork comprising:
placing an industrial robotic vacuum system at the entrance to an agricultural air duct;
connecting the industrial robotic vacuum system to a debris collection system;
connecting the industrial robotic vacuum system to AC power;
powering up a human machine interface (HMI);
connecting a data cable between the industrial robotic vacuum system and the HMI for transfer of video and other data to and from the HMI;
sending a start command from the HMI to the industrial robotic vacuum system wherein the industrial robotic vacuum system will begin operation according to its programming; and
collecting debris swept up with the industrial robotic vacuum system in the debris collection system.

10. The method of claim 9 wherein the industrial robotic vacuum system programming is configured to:
manipulate the industrial robotic vacuum system within the agricultural air duct.

11. The method of claim 9 wherein the industrial robotic vacuum system programming is configured to control the rotational speed of a brush of the industrial robotic vacuum system.

12. The method of claim 9 wherein the industrial robotic vacuum system programming is configured to move a brush arm assembly toward or away from a centerline of the industrial robotic vacuum system in response to positional data collected by a sensor wherein the sensor senses the proximity of a duct wall.

13. The method of claim 12 wherein the sensor is an ultrasonic sensor.

14. The method of claim 10 wherein the manipulating comprises stopping the motion of the industrial robotic system when a sensor detects a ledge in the agricultural duct and in response to the detecting reverses a direction of the industrial robotic vacuum system.

15. The method of claim 10 wherein the manipulating comprises directing the industrial robotic vacuum system back across a portion of the agricultural duct when a camera detects a condition where debris remains in the duct behind it.

16. The method of claim 10 wherein the manipulating comprises stopping the motion of the industrial robotic system when a sensor detects an end wall in the agricultural duct and in response to the detecting reverses a direction of the industrial robotic vacuum system.

17. The method of claim 9 wherein the connecting the industrial robotic vacuum system to a debris collection system comprises attachment of a 3 inch vacuum hose through which the debris collection system will suck swept agricultural debris.

18. An industrial robotic vacuum system for cleaning agricultural air ducts comprising:
a housing;
a drive system mounted to the housing for propelling the system forward, backward, left, and right using skid steer motion;
one or more articulating brush arm assemblies capable of articulating toward or away from a centerline of the housing, wherein the articulating of the one or more articulating brush arm assemblies allows the system to clean debris from wider or narrower portions of an agricultural duct and wherein the one or more articulating brush arm assemblies comprises:
an articulating arm;
a debris deflector rigidly affixed to the articulating arm to deflect large dense piles of agricultural debris toward the centerline of the housing;
an arm brush head assembly mounted to the articulating arm; and
an arm brush motor mounted to the articulating arm for rotating the arm brush head assembly;
a recovery strap attached to a rear side of the housing for retrieval of the system in the event of a system failure;
a vacuum duct assembly attached to the housing for collecting swept debris; and
a front roller sweeper mounted to a front opening of the vacuum duct assembly for directing debris swept from the one or more articulating brush arm assemblies into the duct assembly

19. The system of claim 18 wherein the one or more articulating brush arm assemblies further comprises one or more sensors for sensing the proximity of the one or more brush arm assemblies to a duct wall.

20. The system of claim 19 wherein one or more cameras are mounted to the housing for inspecting the presence of debris.
